(19) United States
(12) Patent Application Publication
(10) Pub. No.: US 2007/0284253 A1
(43) Pub. Date: Dec. 13, 2007

(54) Fuel cell water management

(76) Inventors: Tibor Fabian, Mountain View, CA (US); Shawn Litster, Stanford, CA (US); Juan G. Santiago, Stanford, CA (US); Cullen Bule, Palo Alto, CA (US); Hldeakl Tsuru, Columbus, OH (US); Jun Sasahara, Kawagoe-shi (JP); Tadahlro Kubota, Asaka (JP)

Correspondence Address: LUMEN INTELLECTUAL PROPERTY SERVICES, INC., 2345 YALE STREET, 2ND FLOOR, PALO ALTO, CA, 94306, US

(21) Appl. No.: 11/805,990

(22) Filed: May 24, 2007

Related U.S. Application Data
(60) Provisional application No. 60/808,492, filed on May 25, 2006.

(51) Int. Cl. B01D 61/42; H01M 8/04

(52) U.S. Cl. 204/518; 429/34

(57) ABSTRACT

A polymer electrolyte membrane fuel cell water management device is provided. The device includes a hydrophilic water transport element spanning from inside the fuel cell to outside the fuel cell and disposed between a gas diffusion layer and a current collector layer in the cell. The transport element includes an intermediate wick outside the fuel cell that is hydraulically coupled to the transport element, and has a transport element structure integrated with a flow field structure within the fuel cell. The device further includes an electroosmotic pump, where the pump is located outside the fuel cell and is hydraulically coupled to the intermediate wick. The hydraulically coupled pump actively removes excess water from the flow field structure and the gas diffusion layer through the transport element, where a key aspect of the invention is the decoupling of water removal from oxidant delivery and reduced parasitic loads.

### FIELD OF THE INVENTION

The invention relates generally to fuel cells. More particularly, the invention relates to fuel cells with wicking elements spanning from inside to outside the fuel cell with an outside wick portion hydraulically coupled to an elecroosmotic pump for water management.

### BACKGROUND

Proton exchange membrane (PEM) fuel cells, also known as polymer electrolyte membrane fuel cells, require humidified gases to maintain proper membrane humidification. Water management is a persistent challenge for PEM fuel cells with perfluorosulfonic acid (PFSA) type membranes, such as Nafion®, which require high water activity for suitable ionic conductivity. Humidification of reactant gases ensures proper humidification of the membrane. Consequently, much of the water produced by the oxygen reduction reaction at the cathode is generated in liquid form. Several problems exists when the liquid water invades the pores of the catalyst layer and the gas diffusion layer (GDL) and restricts diffusion of oxygen to the catalyst. The primary problems occur when liquid water emerges from the GDL via capillary action. The water accumulates in gas channels, covers the GDL surface, thus increasing the pressure differentials along flow field channels, and creating flow maldistribution and instability. In-situ and ex-situ visualizations show that considerable flooding occurs in the GDL directly under the rib of the flow field, these effects occur in serpentine systems and in systems with multiple parallel channels.

Currently, excessive air flow rates and serpentine channel designs are used to mitigate flooding at the cost of system efficiency. The air flow rates are large enough to force liquid water out of the system and the serpentine channels are for water accumulation at the cathode, where the serpentine channels minimize flow instabilities and are most commonly a small number of serpentine channels in parallel. These strategies act in concert as serpentine designs increase flow rate per channel, improving the advective removal of water droplets. Air is often supplied at a rate several times greater than that required by the reaction stoichiometry, increasing the oxygen partial pressure at the outlet. The larger applied pressure differentials required for these designs further reduce flooding since the pressure drop reduces local relative humidity, favoring increased evaporation rates near the cathode outlet. The use of high flow rate and high pressure contributes to air delivery being one of the largest parasitic loads on fuel cells. Miniaturization of forced air fuel cells exacerbates this parasitic load issue as the efficiency of miniaturized pumps and blowers is typically much lower than that of macroscale pumps. Parallel channels can reduce the pressure differential across the flow field by orders of magnitude compared to serpentine channels. A parallel channel design also simplifies flow field machining and can enable novel fabrication methods. However, truly parallel channel architectures are typically impractical as they are prone to unacceptable non-uniformity in air streams and catastrophic flooding. Typically, oxygen stoichiometries greater than four are necessary to prevent parallel channel flooding.

To date, several passive water strategies employ additional components to mitigate flooding. One attempt fabricated a composite flow field plate featuring a thin water absorbing layer and waste channels for removing liquid water from the oxidant channels. This design, however, did not offer improved power density due to a significant increase in the Ohmic losses introduced by the new components.

Another attempt used active water management strategies in which applied pressure differentials actively transport liquid water out of or into a fuel cell. A PEM fuel cell was made that actively managed the water content of the electrolyte by supplying pressurized water to wicks that were integrated into the membrane, where water was directly injected to the membrane. This approach had the undesirable effect of increased the parasitic loads and larger fuel cell size.

In another design removes water through porous plates, where a bipolar plate that is porous and has internal water channels for cooling and water removal was used. An applied pressure differential between the gas and water streams drives liquid water from the air channels and into internal channels dedicated to water transport. This attempt requires completely porous plates dedicated to internal water channels, where the system is complex requiring thick porous plates for relatively low volumetric power density.

Accordingly, there is a need to develop a water management device that reduces or eliminates the need for excessive air flow rates and large pressure differentials to reduce the largest parasitic loads on fuel cells, while providing an improved power density. There is an even greater need for such a device with miniaturized fuel cells, where the forced air exacerbates the parasitic load issue with the low-efficiency of miniaturized pumps and blowers. Further, there is a need for a water management device that enable use of parallel channels to reduce the pressure differential across the flow field, where flow field machining is simplified. It would be considered an advance in the field to provide a water management device that enables oxygen stoichiometries less than four without the onset of parallel channel flooding.

### SUMMARY OF THE INVENTION

The current invention provides a polymer electrolyte membrane fuel cell water management device. The device includes a hydrophilic water transport element spanning from inside the fuel cell to outside the fuel cell and disposed between a gas diffusion layer and a current collector layer in the cell. The transport element includes an intermediate wick outside the fuel cell that is hydraulically coupled to the transport element, and includes a transport element structure integrated with a flow field structure within the fuel cell. The device further includes an electroosmotic pump, where the pump is located outside the fuel cell and is hydraulically coupled to the intermediate wick. The hydraulically coupled pump actively removes excess water from the flow field structure and the gas diffusion layer through the transport element, where a key aspect of the invention is the decoupling of water removal from oxidant delivery.

According to the current invention, the electroosmotic pump includes a secondary porous structure layer, a porous pumping element, at least two electrodes, and a housing, where the secondary porous structure layer and the intermediate wick are hydraulically coupled. The housing holds the secondary porous structure coupled to the porous pumping element, and holds the electrodes about the intermediate wick and porous structure, whereby the water is rejected from the cell.

According to one aspect of the invention, the secondary porous structure layer is an electrical insulator between the pump and the fuel cell. The secondary porous structure layer is a particle filter to the pump, where the secondary porous structure layer can be polyvinyl alcohol sponge, glass microfiber, cotton paper, cotton cloth, wool felt, polyurethane foams, cellulose acetate, crosslinked polyvinyl pyrrolidone, or polyacrylamide. The porous pumping element can be glass-particle-packed fused silica capillaries, porous borosilicate glass, in situ polymerized porous monoliths, bulk-micromachined and anodically-etched porous silicon, aluminum oxide, porous silicon, or porous titanium oxide. In another aspect, the electroosmotic pump further includes an electric potential across the porous pumping element, where the electric potential is sufficient to induce a Columbic force on a mobile ion layer on the porous pumping element, whereas a viscous interaction between the mobile ions and the water generates a bulk flow. The electric potential across the porous pumping element can be a time varying potential, thus reducing parasitic loads to the fuel cell. The electric potential can be activated when flooding or dry-out is detected or imminent, whereby reducing parasitic loads to the fuel cell.

According to another aspect of the invention, the fuel cell can be a fuel cell stack including at least two fuel cells. In one aspect, the fuel cell stack has a wicking bus disposed between the pump and multiple layers of the transport element, where the bus is operated by at least one EO pump. The bus can be a dielectric wick disposed outside the fuel cell, where when the dielectric wick saturates with water the dielectric wick hydraulically connects the transport elements with the pump and insulates an electric field of the cell from an electrical field of the pump. In a further aspect, the dielectric wick can be made from polyvinyl alcohol sponge, glass microfiber, cotton paper, cotton cloth, wool felt, polyurethane foams, cellulose acetate, crosslinked polyvinyl pyrrolidone, or polyacrylamide.

According to one aspect of the invention, the transport element is an electrically conductive wick. The electrically conductive wick can be made from a material including carbon cloth, carbon paper, aluminum foam, stainless steel foam or nickel foam.

In another aspect of the invention, the transport element is a porous hydrophilic water transport layer disposed between a bipolar plate and a gas diffusion layer in the fuel cell, where the water transport layer is hydraulically connected to the external electroosmotic pump.

In a further aspect of the invention, the transport element is a porous hydrophilic water transport layer having a pattern of cut-outs or a pattern of hydrophobic regions a pattern of cut-outs and/or a pattern of hydrophobic regions arranged in a pattern, where the transport layer is hydraulically continuous, allowing for the fuel cell reactant gasses to flow freely through the transport layer in a direction perpendicular to the plane of the transport layer, where the transport layer is disposed between a gas diffusion layer and a current collector layer in the fuel cell. The transport layer is hydraulically connected to the external electroosmotic pump.

According to another aspect of the invention, the electroosmotic pump is disposed to humidify a membrane electrode assembly when using dry gases and low humidity gases in the flow fields.

In one aspect of the invention, the electroosmotic pump is disposed to humidify hydrogen in an anode current collector on the fuel cell.

In another aspect, the electroosmotic pump actively distributes water in the cell between a cathode region and an anode region of the fuel cell.

The proposed water management solution eliminates large fuel cell humidifier systems and reduces the size of air supply system by reducing the air flow requirements. This translates into reduction of power consumption, and complexity of auxiliary devices. Consequently, the proposed water management solution reduces the overall cost by reduction of system complexity and use of cost effective materials.

### BRIEF DESCRIPTION OF THE FIGURES

The objectives and advantages of the present invention will be understood by reading the following detailed description in conjunction with the drawing, in which:

FIG. 1(a) shows a planar cutaway schematic view of a fuel cell and EO pump assembly according to the present invention.

FIG. 1(b) shows a perspective exploded view of a fuel cell plate and EO pump assembly according to the present invention.

FIGS. 2a-2b show planar schematic views of the current invention.

FIG. 3 shows a partial cutaway perspective view of an integrated cathode/transport element embodiment according to the present invention.

FIG. 4 shows a planar schematic view of transport phenomena related to water transport in PEM fuel cells.

FIG. 5 shows a planar schematic view of cell water management according to the present invention.

### DETAILED DESCRIPTION OF THE INVENTION

Although the following detailed description contains many specifics for the purposes of illustration, anyone of ordinary skill in the art will readily appreciate that many variations and alterations to the following exemplary details are within the scope of the invention. Accordingly, the following preferred embodiment of the invention is set forth without any loss of generality to, and without imposing limitations upon, the claimed invention.

The current invention provides an active water management system utilizing electroosmtic (EO) pumps for redistributing and removing liquid water. Transient and polarization data demonstrate that the active removal of water with EO pumping according to the current invention eliminates flooding with a low parasitic load (˜10% of the fuel cell power). The EO pump uses an electric double layer (EDL) that forms between solid surfaces and liquids. By using porous glass EO pump structures, silanol groups on the surface of the glass spontaneously deprotonate, and create a negative surface charge and a net-positive layer of mobile ions with a generated potential of roughly −60 mV (a typical zeta potential for deionized water). Applying electric potential across a porous glass substrate induces a Columbic force on this mobile ion layer. The viscous interaction between ions and water generates a bulk flow. In the present invention, the working flow rate through an EO pump is a linear function of pressure load and the electric field imposed across the pump. The EO pump flow rates scale linearly with area, an appropriate scaling for fuel cells whose output power and water production rate also scale with area. According to the current invention, EO pumps present a negligible parasitic load. The EO pump is hydraulically coupled to an internal wick structure.

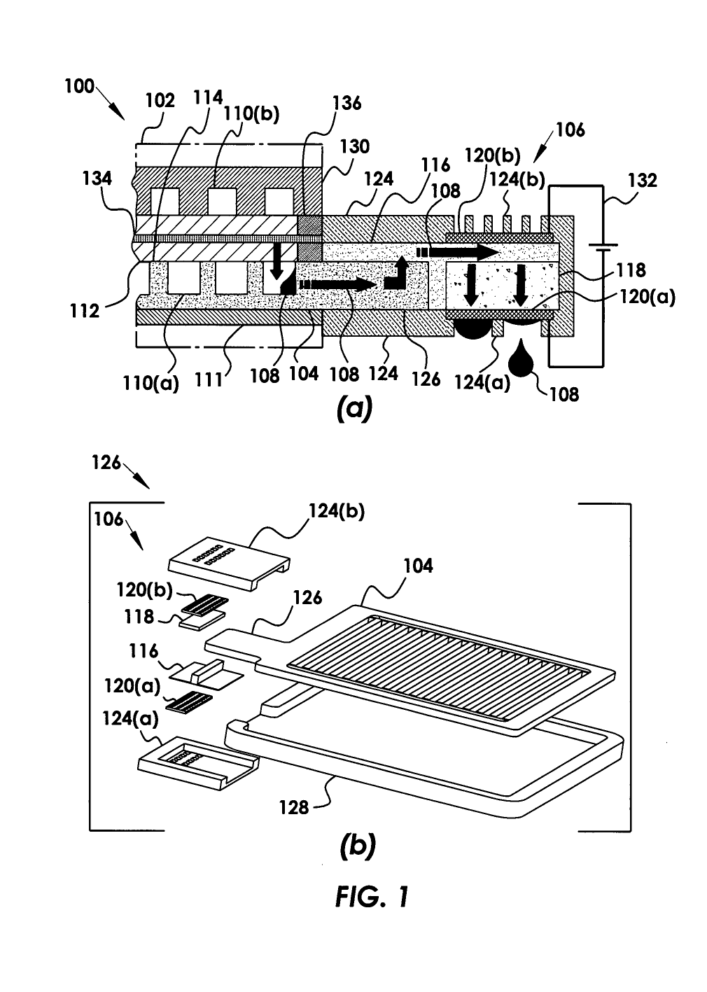

Referring to the figures, FIG. 1(a) shows a planar cutaway schematic view of a fuel cell and EO pump assembly 100. Shown is a fuel cell 102 with a hydrophilic water transport element 104 and an external EO pump 106 with water flow 108 in the assembly 100. The hydrophilic transport element 104 absorbs water droplets 108 from the cathode channels 110(a) (also known as flow field) of a cathode current collector 111 and gas diffusion layer 112, including water 108 that normally accumulates under the rib 114 of the flow field 110(a). Upon saturation with absorbed water 108, the hydrophilic transport element 104 can no longer remove water without application of a pressure gradient to force water 108 across the hydrophilic transport element 104. This forced transport action is accomplished by the external EO pump 106. The EO pump 106 and the hydrophilic transport element 104 are hydraulically coupled through a secondary porous structure layer 116 which serves as both an easily-compressed coupler between the hydrophilic transport element 104 and a porous pumping element 118 that also keeps particles (e.g., carbon residue) from clogging the pump 106. Furthermore, the non-conductive porous pumping element 118 helps to electrically isolate the pump 106 from the fuel cell 102. According to the invention, the EO pump 106 is in close proximity to the air outlet (not shown) to exploit air pressure gradients within the cathode flow field 110(a) in removing water 108 from the transport element 104. The EO pump 106 further has at least two electrodes 120, and a housing 124, where the housing 124 holds the secondary porous structure 116, the porous pumping element 118, the electrodes 118 about an intermediate wick 126, where the water is rejected from the cell. The intermediate wick 126 is hydraulically connected to the transport element 104, where the intermediate wick 126 represents a portion of the transport element 104 that is outside the cell 102. Further shown, is an anode current collector 130 having anode flow channels 110(b), a membrane electrode assembly (MEA) 134 disposed between the gas diffusion layers 112, and a seal 136 surrounding the gas diffusion layers 112 to seal the gases.

FIG. 1(b) shows a perspective exploded view of a fuel cell plate and EO pump assembly 126 that includes the transport element 104 and external EO pump 106. Here, the transport element 104 is shown as a hydrophilic porous flow field plate having an integrated intermediate wick 126 that is hydraulically coupled to the external EO pump 106. Further shown is a solid graphite base 128 for holding the transport element 104.

As shown, the secondary porous structure layer 116 has a horizontal tab that is disposed between the pump anode 120(a) (pump inlet) and the porous pumping element 118, where an opposite horizontal tab of the secondary porous structure layer 116 is disposed between the housing 124 and the intermediate wick 126 (or the portion of the transport element 104 that is outside the cell 102) of the hydrophilic transport element 104. The secondary porous structure layer 116 is very hydrophilic and can have relatively large pores (as small as 10 μm) for low hydraulic resistance. The secondary porous structure layer 116 further can have an uncompressed porosity of 90%. The housing 124 consists of two plates which compress both the pump elements and the interface of the secondary porous structure layer 116 and porous pumping element 118. The pump's anode housing plate 124(b) has small openings (˜1 by 1 mm) to allow the oxygen generated by electrolysis to escape. The pump cathode housing plate 124(a) has larger openings for the pump's water outlet.

The secondary porous structure layer 116 can be an electrical insulator between the EO pump 106 and the fuel cell 102. The secondary porous structure layer 116 provides a particle filter to the pump 104, where the secondary porous structure layer 116 can be made from polyvinyl alcohol sponge, glass microfiber, cotton paper, cotton cloth, wool felt, polyurethane foams, cellulose acetate, crosslinked polyvinyl pyrrolidone, or polyacrylamide. Additionally, the porous pumping element 118 can be made from glass-particle-packed fused silica capillaries, porous borosilicate glass, in situ polymerized porous monoliths, bulk-micromachined and anodically-etched porous silicon, aluminum oxide, porous silicon, or porous titanium oxide.

The EO pump 106 can further include an electric potential across the porous pumping element 118, where the electric potential is sufficient to induce a Columbic force on a mobile ion layer on the porous pumping element 118, whereas a viscous interaction between mobile ions and water generates a bulk flow (not shown). The electric potential across the porous pumping element 118 can be a time varying potential, thus reducing parasitic loads to the fuel cell 102. The electric potential can be activated when flooding or dry-out is detected or imminent, whereby reducing parasitic loads to the fuel cell 102.

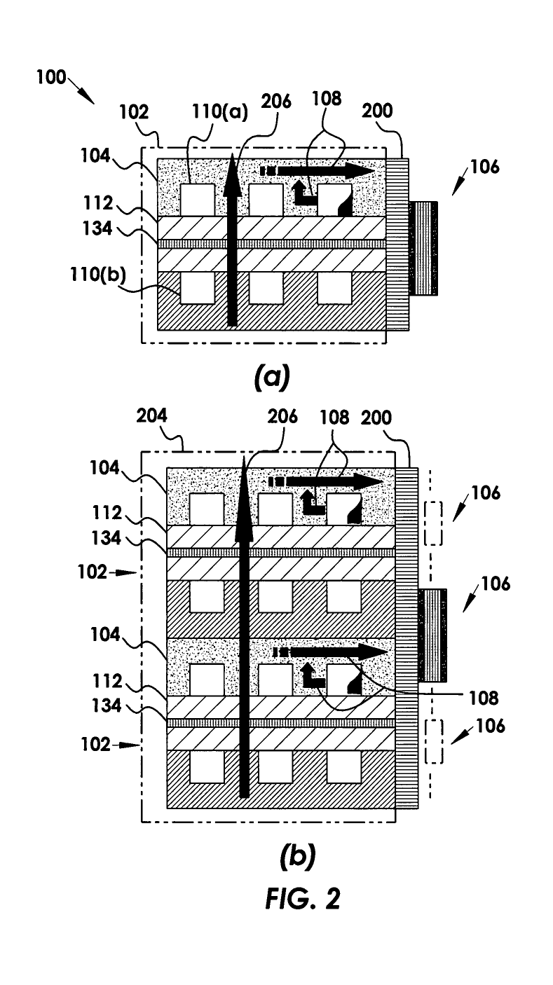

FIGS. 2a-2b show planar schematic views of the current invention having a PEM fuel cell 102 with active water removal through an integrated water transport element 104, where the liquid flow 108 is driven by an external EO pump 106. As shown, water 108 is removed from the channels 110(a) and from the gas diffusion layer 112 underneath the ribs 114 (see FIG. 1(a)) and transported to a wicking bus 200 that hydraulically connects the transport element 104 to the EO pump 106. Current flow 206 is shown spanning across the fuel cell 102. Shown in FIG. 2(b) is a fuel cell stack 204 having at least two fuel cells 102. As shown, the fuel cell stack 204 has a wicking bus 200 disposed between the EO pump 106 and multiple layers of the transport element 104, where the bus 200 is operated on by at least one EO pump 106. When considering large area fuel cells 102, such as for automobile usage, rapid response to saturation is important, where multiple EO pumps 106 (shown in dashed lines) can be connected to the bus 200 to minimize the distance required for the water to travel. The bus 200 can be a dielectric wick disposed outside the fuel cell 102. When the dielectric wick 200 saturates with water it hydraulically connects the transport elements 104 with the pump 106, while insulating the electric field of the fuel cell 104 from the electrical field of the pump 106. According to the current invention, the dielectric wick 200 can be made from polyvinyl alcohol sponge, glass microfiber, cotton paper, cotton cloth, wool felt, polyurethane foams, cellulose acetate, crosslinked polyvinyl pyrrolidone, or polyacrylamide.

In one embodiment of the current invention, the EO pump 106 is disposed to humidify the membrane electrode assembly (MEA) 134 when using dry gases and low humidity gases in the flow fields 110. The EO pump 106 is further disposed to humidify hydrogen in the anode current collector 110(b) on the fuel cell 102, and/or disposed to actively distribute water 108 in the cell 102 between a cathode current collector 111 region and an anode current collector 130 region of the fuel cell 102 (not shown).

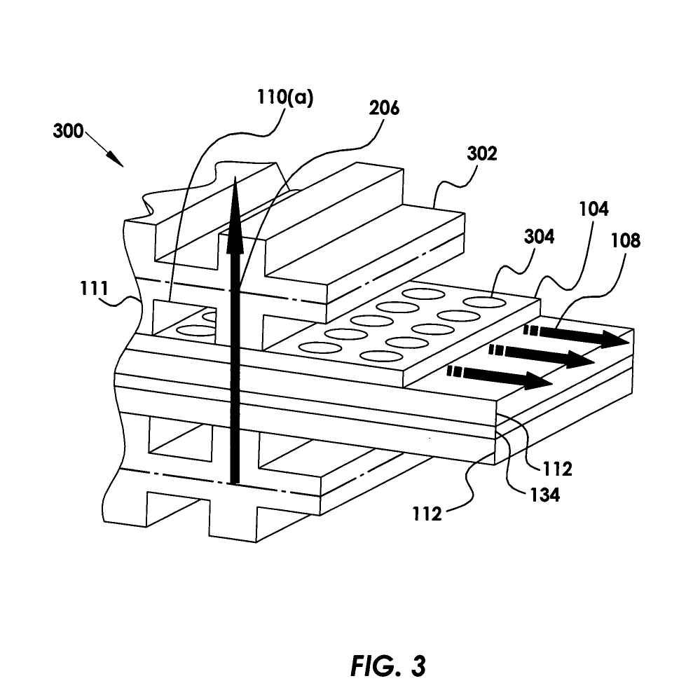

According to the invention, the transport element 104 can be an electrically conductive wick. The electrically conductive wick 104 can be made from a material including carbon cloth, carbon paper, aluminum foam, stainless steel foam or nickel foam. FIG. 3 shows a partial cutaway perspective view of an integrated cathode 111/transport element 104 embodiment 300 of the invention, where the transport element 104 is a porous hydrophilic water transport layer disposed between a bipolar plate 302 and a gas diffusion layer 112 in the fuel cell 102. The water transport layer 104 is hydraulically connected to the external electroosmotic pump 106 (not shown). The porous hydrophilic water transport layer 104 is shown having a pattern of gas permeable regions 304, where the regions 304 are formed either as cut-outs or as locally hydrophobic zones of the hydrophilic transport layer 104, where the transport layer remains hydraulically continuous. The gas permeable areas 304 enable rapid oxygen diffusion from the gas diffusion layer 112 into the channel 110(a) even as the transport layer 104 is fully saturated with water. As the transport layer 104 conducts electricity 308 to the cathode 111 portion of the bipolar plate 302 it simultaneously transports water 108 from the cell 102 when hydraulically coupled to the EO pump 106. The integrated embodiment 300 provides advantages of being thin, independent to the design of bipolar plate 302, and low ohmic resistance.

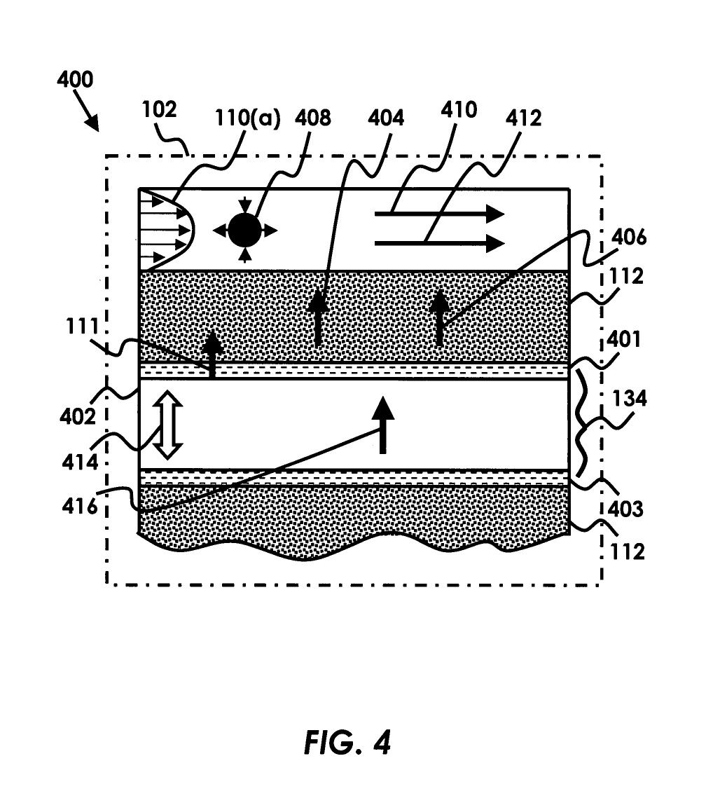

FIG. 4 shows a planar schematic view of transport phenomena 400 related to water transport in PEM fuel cells 102 having a MEA 134 disposed between two gas diffusion layers 112, where according to the current invention, the MEA 134 a MEA is a membrane 402 with two catalyst layers consisting of a cathode catalyst layer 401 and a anode catalyst layer 403. As shown, there are parallel and coupled mechanisms for transporting liquid and vapor within each distinct region of the fuel cell 102; each having its own characteristic transport physics. Water produced in the cathode 111 travels to the gas channels 110(a) by vapor diffusion 404 and (liquid) capillary transport 406. The vapor and liquid are coupled through phase change phenomena 408. Once in the channels 110(a), water 108 is removed from the fuel cell 102 by vapor advection 410 and droplet advection 412. Additional water 108 may travel from the anode 130 to cathode 111 (see FIG. 1), or vice versa, by a diffusion/hydraulic permeation combination 414, and electroosmotic drag 416. Flooding occurs and performance deteriorates when these mechanisms inadequately remove liquid water 108, thus restricting oxygen from reaching the cathode catalyst layer 401. By integrating EO pumps 106 and wicking structures 104 into PEM fuel cells 102 a comprehensive water management device is provided to address water removal limitations.

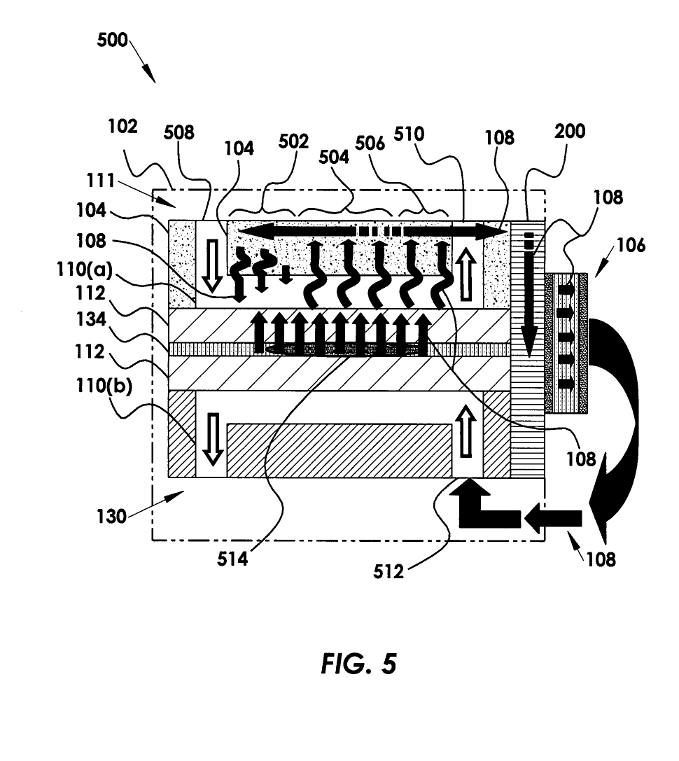

FIG. 5 is a planar schematic view of cell water management 500 showing simultaneous MEA 134 hydration and mitigated flooding while operating the fuel cell 102 with negligible parasitic load. The electrically conductive transport element 104 rapidly absorbs water 108 by capillary action 404 (not shown) when the transport element 104 is unsaturated. The schematic shows an air hydration region 502, a water redistribution region 504 and a water removal region 506 of the transport element 104. If the air supply at the inlet 508 has a relative humidity below 100%, the water 108 absorbed by the transport element 104 near the outlet 510 is redistributed to dry regions up-stream by capillary forces 404, during this time water 108 evaporates to humidify the air stream and improve membrane 134 conductivity. In the regions of evaporation, the latent heat of phase change removes heat produced by the fuel cell 102. When water 108 completely saturates the system, including the dielectric wick 200 and EO pump 106, the EO pumps circuit 132 (see FIG. 1) is closed and the pump 106 is automatically activated. The pump 106 then generates a pressure gradient that removes excess water 108. In the current embodiment, the EO pump 106 is disposed to humidify hydrogen in the anode current collector 130 on the fuel cell 102 such that the EO pump 106 actively distributes water 108 in the cell 102 between the cathode 111 region and the anode 130 region, where the water 108 removed by the EO pump 106 is diverted to the anode 130 for humidifying the hydrogen (not shown) at the hydrogen inlet 512.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. For example, it can be extended to planar, air-breathing fuel cell designs. All such variations are considered to be within the scope and spirit of the present invention as defined by the following claims and their legal equivalents.

What is claimed is:

1. A polymer electrolyte membrane fuel cell water management device comprising:
a. a hydrophilic water transport element spanning from inside said fuel cell to outside said fuel cell and disposed between a gas diffusion layer and a current collector layer in said cell, wherein said transport element comprises:
i. an intermediate wick outside said fuel cell that is hydraulically coupled to said transport element;
ii. a transport element structure integrated with a flow field structure within said fuel cell; and
b. an electroosmotic pump, wherein said pump is located outside said fuel cell and coupled to said intermediate wick, whereas said pump is hydraulically coupled to said intermediate wick to actively remove excess water from said flow field structure and said gas diffusion layer through said transport element, whereby said water removal is decoupled from oxidant delivery.

2. The water management device of claim 1, wherein said electroosmotic pump comprises;
a. a secondary porous structure layer, wherein said secondary porous structure layer and said intermediate wick are hydraulically coupled;
b. a porous pumping element;
c. at least two electrodes; and
d. a housing, wherein said housing holds said secondary porous structure, said porous pumping element, and said electrodes about said intermediate wick, whereby said water is rejected from said cell.

3. The water management device of claim 2, wherein said secondary porous structure layer is an electrical insulator between said pump and said fuel cell.

4. The water management device of claim 2, wherein said secondary porous structure layer is a particle filter to said pump.

5. The water management device of claim 2, wherein said secondary porous structure layer is selected from a group consisting of polyvinyl alcohol sponge, glass microfiber, cotton paper, cotton cloth, wool felt, polyurethane foams, cellulose acetate, crosslinked polyvinyl pyrrolidone, and polyacrylamide.

6. The water management device of claim 2, wherein said porous pumping element is selected from a group consisting of glass-particle-packed fused silica capillaries, porous borosilicate glass, in situ polymerized porous monoliths, bulk-micromachined and anodically-etched porous silicon, aluminum oxide, porous silicon, and porous titanium oxide.

7. The water management device of claim 2, wherein said electroosmotic pump further comprises an electric potential across said porous pumping element, whereby said electric potential is sufficient to induce a columbic force on a mobile ion layer on said porous pumping element, whereas a viscous interaction between said mobile ions and said water generates a bulk flow.

8. The water management device of claim 7, wherein said electric potential across said porous pumping element is a time varying potential, whereby reducing parasitic loads to said fuel cell.

9. The water management device of claim 7, wherein said electric potential is activated when flooding or dry-out is detected or imminent, whereby reducing parasitic loads to said fuel cell.

10. The water management device of claim 1, wherein said fuel cell is a fuel cell stack, whereby said stack comprises at least two said fuel cells.

11. The water management device of claim 10, wherein said fuel cell stack comprises a wicking bus disposed between said pump and multiple layers of said transport element, whereby said bus is operated on by at least one said pump.

12. The water management device of claim 11, wherein said bus is a dielectric wick disposed outside said fuel cell, whereas when said dielectric wick saturates with water said dielectric wick hydraulically connects said transport elements with said pump and insulates an electric field of said cell from an electrical field of said pump.

13. The water management device of claim 12, wherein said dielectric wick is selected from a group consisting of polyvinyl alcohol sponge, glass microfiber, cotton paper, cotton cloth, wool felt, polyurethane foams, cellulose acetate, crosslinked polyvinyl pyrrolidone, and polyacrylamide.

14. The water management device of claim 1, wherein said transport element is an electrically conductive wick.

15. The water management device of claim 14, wherein said electrically conductive wick is made from a material selected from a group consisting of carbon cloth, carbon paper, aluminum foam, stainless steel foam and nickel foam.

16. The water management device of claim 1, wherein said transport element is a porous hydrophilic water transport layer disposed between a bipolar plate and a gas diffusion layer in said fuel cell, whereby said water transport layer is hydraulically connected to said external electroosmotic pump.

17. The water management device of claim 1, wherein said transport element is a porous hydrophilic water transport layer comprising a pattern of cut-outs and/or a pattern of hydrophobic regions arranged in a pattern whereas said transport layer is hydraulically continuous, whereby said transport layer is disposed between a gas diffusion layer and a current collector layer in said fuel cell, whereas said transport layer is hydraulically connected to said external electroosmotic pump.

18. The water management device of claim 1, wherein said electroosmotic pump is disposed to humidify a membrane electrode assembly when using dry gases and low humidity gases in said flow fields.

19. The water management device of claim 1, wherein said electroosmotic pump is disposed to humidify hydrogen in an anode current collector on said fuel cell.

20. The water management device of claim 1, wherein said electroosmotic pump actively distributes water in said cell between a cathode region and an anode region of said fuel cell.
